(19) United States
(12) Patent Application Publication
(10) Pub. No.: US 2026/0050762 A1
(43) Pub. Date: Feb. 19, 2026

(54) METHOD FOR SIMULATING WORK ROLES BASED ON VIRTUAL ROBOT, VIRTUAL ROBOT AND ELECTRONIC DEVICE

(71) Applicant: SHENZHEN AURORA TECHNOLOGY LIMITED, Shenzhen (CN)

(72) Inventor: Qingbo XIE, Shenzhen (CN)

(73) Assignee: SHENZHEN AURORA TECHNOLOGY LIMITED, Shenzhen (CN)

(21) Appl. No.: 19/023,155

(22) Filed: Jan. 15, 2025

(30) Foreign Application Priority Data
Aug. 19, 2024 (CN) 202411132402.7

(51) Int. Cl. G06N 3/006

(52) U.S. Cl. CPC G06N 3/006

(57) ABSTRACT

Disclosed are a method for simulating work roles based on a virtual robot, a virtual robot and an electronic device. The method includes: selecting a simulation object; selecting a virtual robot and adding a skill software package; selecting a replaceable work project, parsing software, determining authority, and constructing an initial logic chain of the work project; obtaining terminal data through the virtual robot, and obtaining habit data of the simulation object from the terminal data; coupling the habit data to the initial logic chain to obtain a habitual logic chain, granting the virtual robot authority, and allowing the virtual robot to imitate the habits of the simulation object according to the habitual logic chain to execute the work project.

### CROSS-REFERENCE TO RELATED APPLICATIONS

The present application claims priority to Chinese Patent Application No. 202411132402.7, filed on Aug. 19, 2024, the entire contents of which are incorporated herein by reference.

### TECHNICAL FIELD

The present application relates to the technical field of role simulation, and in particular to a method for simulating work roles based on a virtual robot, a virtual robot and an electronic device.

### BACKGROUND

With the rapid development of artificial intelligence technology, virtual robots are increasingly used in various industries, especially in simulating human work roles and performing specific work tasks. Traditionally, corporate organizations rely on manual labor to complete various complex and repetitive tasks, such as data analysis, customer service, production scheduling, etc. However, this method has problems such as low efficiency, high cost, and error-proneness. In addition, with the continuous change of business needs, the skill requirements for employees are also constantly increasing, resulting in long training cycles and poor adaptability.

In the related art, although there are some automation tools and robotic process automation solutions that attempt to solve the above problems, they are often limited to predefined rules and processes, lack flexibility and learning ability, and cannot effectively adapt to changes in workflows or differences in personal work habits. Furthermore, these systems often fail to make full use of the experience and knowledge of existing employees when simulating specific work roles, which limits the effect and depth that automation can achieve.

Therefore, there is an urgent need for an innovative method that can simulate specific work roles more accurately.

### SUMMARY

Based on the problems existing in the related art, the present application provides a method for simulating work roles based on a virtual robot, a virtual robot and an electronic device The specific scheme is as follows:

The present application provides a method for simulating work roles based on a virtual robot, including the following steps:
selecting a simulation object corresponding to a target work role, and parsing role information, work responsibilities and skill information of the simulation object;
selecting the virtual robot based on the role information and the work responsibilities, and adding a skill software package corresponding to the skill information to the virtual robot to enable the virtual robot to call the skill software package to perform tasks;
selecting a work project executed by the simulation object at a terminal and capable of being replaced in the work responsibilities; parsing an execution process and a software involved in the work project; determining authority required for the virtual robot to execute the work project, and constructing an initial logic chain of the work project based on the execution process;
in a process of the simulation object executing the work project, obtaining terminal data of the simulation object when executing the work project at the terminal through the virtual robot, filtering out a project data related to the work project from the terminal data, and obtaining habit data of the simulation object by analyzing the project data; and
coupling the habit data to the initial logic chain to obtain a habitual logic chain, and giving the virtual robot a same authority as the simulation object to enable the virtual robot to imitate a habit of the simulation object according to the habitual logic chain to execute the work project.

In an embodiment, the the virtual robot executing the work project includes the following steps:
in response to that requirements of the work project are the same as one or more requirements recorded in the project data, enabling the virtual robot to directly repeat the execution according to a processing method recorded in the project data; and
in response to that the requirements of the work project are different from all the requirements recorded in the project data, but similar to one or more requirements, enabling the virtual robot to compare characteristics of requirements of a current work project and characteristics of similar requirements in the project data to identify differences, and intelligently adjusting corresponding links in the habitual logic chain based on the differences to achieve intelligent execution.

In an embodiment, the method for simulating work roles based on a virtual robot, further includes the following steps: in response to that the requirements of the work project are neither the same nor similar to all the requirements recorded in the project data, enabling the virtual robot to analyze requirements of the current work project, construct a new initial logic chain, merge the habit data into the new initial logic chain to obtain a new habitual logic chain, and execute the work project in a manner that imitates the simulation object in the face of new requirements according to the new habitual logic chain.

In an embodiment, the virtual robot is given a permission to start background screen recording in response to that the software is running, obtaining the terminal data by recording a screen of the simulation object when executing the work project at the terminal within a target period;
analyzing the terminal data frame by frame, and comparing whether there is a distinction between two adjacent frame images;
marking frame images with distinctions as change frames, and searching for change areas in all change frames;
based on running logic of the software, analyzing an operation behavior of the simulation object and interface changes corresponding to the operation behavior from the change area, and obtaining project data of the target time period after confirmation by the simulation object; and
summarizing project data of each period, analyzing basis data of the simulation object performing the operation behavior according to the running logic of the software and the interface changes corresponding to the operation behavior, and obtaining habit data of the simulation object by combining the basis data and the corresponding operation behavior.

In an embodiment, the virtual robot includes an artificial virtual robot and one or more functional models, and the artificial virtual robot is able to call each functional model and select the functional model based on the skill information; and
in a preset database, virtual robots divided by work roles are pre-stored, and role information of the virtual robot including age, gender, and education level is capable of being customized and marked with skill labels of corresponding functional models; determining basic skills required to complete the work responsibilities, and searching for virtual robots with corresponding skill labels in the preset database based on the basic skills.

In an embodiment, a process of obtaining the project data includes the following steps:
monitoring a terminal operation of the simulation object in real time when the simulation object executing a target work project to obtain the terminal data, wherein the terminal operation includes keyboard input, mouse movement, click, program interaction of a window to manage the virtual robot;
collecting a timestamp, a sequence and a frequency of each terminal operation to form a corresponding operation log, and incorporating the operation log into the terminal data; and
filtering out data directly related to a selected work project from the terminal data, and eliminating irrelevant data through identification methods including keyword search, application identifier identification or specific operation mode identification to obtain the project data.

In an embodiment, a process of obtaining the habit data includes the following steps:
using a pre-trained habit analysis model to analyze the project data, obtaining a habit pattern of the simulation object when the simulation object executing the work project through clustering similar operations, in combination with a preset long short-term memory network to analyze related operations in a time dimension, wherein the habit pattern includes a time point of switching software, a target order of processing data, tool options, interface layout and shortcut key usage;
based on the habit pattern, analyzing a most common operation sequence of the simulation object when the simulation object executing the work project, wherein the operation sequence includes a normal working sequence of the simulation object when the simulation object executing the work project, and a decision-making mode and corresponding working sequence when the simulation object facing anomalies; and
summarizing the habit pattern and the operation sequence, and encoding the habit pattern and the operation sequence into a format capable of being parsed by the virtual robot to obtain the habit data.

In an embodiment, the role information includes a position, an age, a gender, and an education of the simulation object;
the work responsibilities include daily tasks and responsibilities of the simulation object;
the skill information includes skills possessed by the simulation object, skills required for the work role, and skills needed by the simulation object but not having; and
the initial logic chain includes source of input data, data processing and analysis, decision-making logic, output result processing, and exception handling mechanism.

The present application provides a virtual robot, including:
a role determination unit, configured to select a simulation object corresponding to a target work role, and parse role information, work responsibilities and skill information of the simulation object;
a model determination unit, configured to select a virtual robot based on the role information and the work responsibilities, and add a skill software package corresponding to the skill information to the virtual robot to enable the virtual robot to call the skill software package to perform tasks;
a pre-processing unit, configured to select a work project executed by the simulation object at a terminal and capable of being replaced in the work responsibilities, parse an execution process and a software involved in the work project, determine authority required for the virtual robot to execute the work project, and construct an initial logic chain of the work project based on the execution process;
data acquisition unit, configured to obtain terminal data of the simulation object when the simulation object executing the work project at the terminal through the virtual robot, filter out project data related to the work project from the terminal data, and obtain habit data of the simulation object by analyzing the project data in a process of the simulation object executing the work project; and
simulation unit, configured to couple the habit data to the initial logic chain to obtain a habitual logic chain, and give the virtual robot a same authority as the simulation object to enable the virtual robot to imitate a habit of the simulation object according to the habitual logic chain to execute the work project.

The present application provides an electronic device, including:
a processor; and
a memory for storing a computer program run on the processor;
the processor, when running the computer program, executes the method for simulating work roles based on the virtual robot as described in the above embodiments.

The present application provides a method for simulating work roles based on a virtual robot, a virtual robot and an electronic device. The virtual robot simulates the habits and workflow of a simulation object corresponding to a target work role, imitates the decision-making mode, operation habits and preference settings of the simulation object, and provides highly personalized and customized services, thereby providing services that are more in line with personal style and improving user experience and satisfaction. When simulating the execution of repetitive and rule-defined tasks, the virtual robot can accurately follow the habitual logic chain and complete the task quickly and accurately, which can greatly improve efficiency and reduce errors caused by human negligence or fatigue.

In order to make the above-mentioned objects, features and advantages of the present application more obvious and easy to understand, embodiments are specifically cited below and described in detail with reference to the attached drawings.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art, other drawings can be obtained based on the structures shown in these drawings without creative work.

FIG. 1 is a schematic structural view of a method for simulating work roles based on a virtual robot according to an embodiment of the present application.

FIG. 2 is a schematic structural view of a hierarchical relationship between the features according to an embodiment of the present application.

FIG. 3 is a schematic view of response principles of the virtual robot when encountering different situations according to an embodiment of the present application.

FIG. 4 is a schematic structural view of a structure of a virtual robot according to an embodiment of the present application.

### DETAILED DESCRIPTION OF THE EMBODIMENTS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments in the present application, all other embodiments obtained by those skilled in the art without creative work are within the scope of protection of the present application.

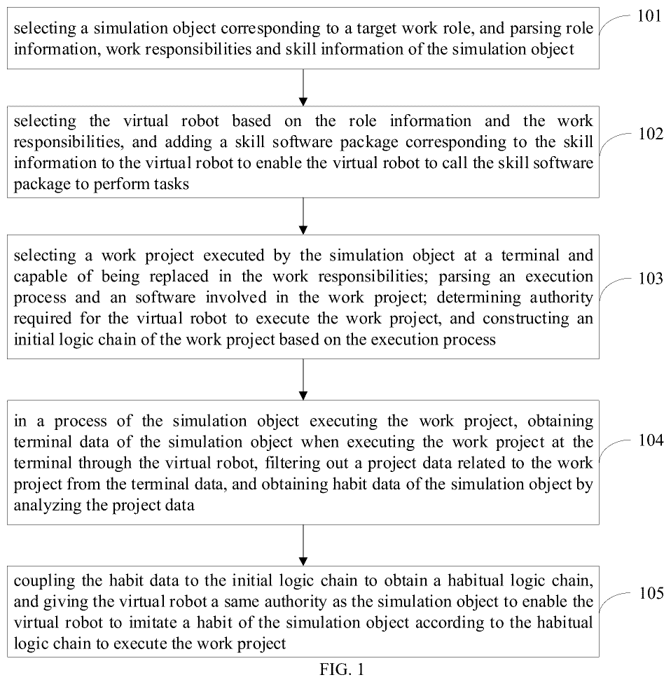

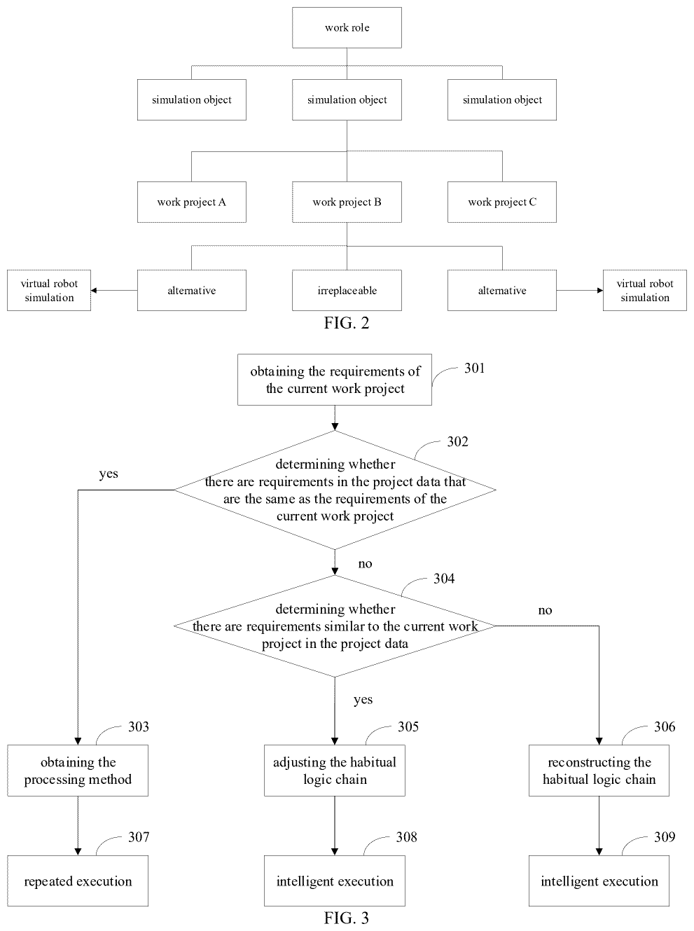

The present application provides a method for simulating work roles based on a virtual robot. The virtual robot simulates the habits and workflow of simulation objects, imitates the decision-making mode, operation habits and preference settings of simulation objects, and provides highly personalized and customized services, thereby providing services that are more in line with personal style and improving user experience and satisfaction. The flowchart of the work role simulation method based on virtual robots is shown in FIG. 1, the principle is shown in FIG. 2, and the scheme is as follows.

A method for simulating work roles based on a virtual robot includes:
step 101, selecting a simulation object corresponding to a target work role, and parsing role information, work responsibilities and skill information of the simulation object.
step 102, in response to that the requirements of the work project are different from all the requirements recorded in the project data, but similar to one or more requirements, enabling the virtual robot to compare characteristics of requirements of a current work project and characteristics of similar requirements in the project data to identify differences, and intelligently adjusting corresponding links in the habitual logic chain based on the differences to achieve intelligent execution.
step 103, selecting a work project executed by the simulation object at a terminal and capable of being replaced in the work responsibilities; parsing an execution process and a software involved in the work project; determining authority required for the virtual robot to execute the work project, and constructing an initial logic chain of the work project based on the execution process.
step 104, in a process of the simulation object executing the work project, obtaining terminal data of the simulation object when executing the work project at the terminal through the virtual robot, filtering out a project data related to the work project from the terminal data, and obtaining habit data of the simulation object by analyzing the project data.
step 105, coupling the habit data to the initial logic chain to obtain a habitual logic chain, and giving the virtual robot a same authority as the simulation object to enable the virtual robot to imitate a habit of the simulation object according to the habitual logic chain to execute the work project.

The method for simulating work roles of the present application applies a virtual robot to a specific simulation object (i.e. the simulation object corresponding to the target work role) under a specific work role (i.e. the target work role) to achieve simulation and enhancement of a specific role, and replaces the specific simulation object to perform related work projects by imitating the habits and preferences of employees, thereby providing more personalized services or products and enhancing user experience. It can not only reduce manual errors, improve work accuracy, accelerate the decision-making process, and significantly improve efficiency, but also reduce long-term labor costs, reduce dependence on manpower through automation, and help avoid costly mistakes. In addition, it can also promote the innovation and competitiveness of enterprises, while creating a more positive and productive working environment for employees.

Among them, the virtual robot is based on an artificial virtual robot and is constructed in combination with various schedulable functional models. The selection of the functional model is based on the skill information and work responsibilities of the selected simulation object, such as data analysis model, text editing model, prediction model, etc. Based on advanced artificial virtual robots, deep learning and other functional models are integrated to achieve highly accurate simulation of specific work roles. The virtual robot adopts a multi-layer neural network structure, especially a convolutional neural network (CNN), a recurrent neural network (RNN), a long short-term memory network (LSTM) or variants such as a Transformer model under a deep learning framework to process complex nonlinear relationships and time series data. Virtual robots should have the ability to self-learn and evolve, and continuously learn from new data through online learning or incremental learning mechanisms to adapt to changes in workflows and updates to personal work habits.

In step 101, it is necessary to select a work role and parse relevant information to provide a basis for subsequent virtual robot selection and skill matching. Step 101 includes: first, selecting a specific work role, such as “marketing manager”, “data analyst”, “personnel manager”, “financial manager” and other specific job titles; secondly, it is necessary to parse the role information, including work description, department, reporting relationship, etc; next, it is necessary to clarify the work responsibilities of the simulation object, such as market research, advertising planning, customer relationship management, etc; finally, according to the specific work responsibilities of the simulation object, determining the skill information required to complete the responsibilities, such as market analysis, creative writing, social media management, data analysis, etc.

It should be noted that a work role is a position, and the simulation object is a specific person with specific work habits. The virtual robot needs to imitate the simulation object and perform certain work tasks according to the work habits of the simulation object. To a certain extent, it replaces the simulation object to perform certain work tasks to reduce its workload.

In an embodiment, role information is a basic description of the role. In addition to basic information such as the position, age, gender, and education of the simulation object, it also includes the position of the role in the organization, the relationship goals with other roles, the expected results of the role, and the criteria for successfully performing the role. Work responsibilities include the daily tasks and responsibilities of the simulation object, that is, the specific work that the role person needs to complete every day or regularly, such as handling customer inquiries, data analysis, or financial reporting. In addition, work responsibilities are also related to measuring the success of the role, involving important indicators such as customer satisfaction, data accuracy, or the timeliness of financial reports. Skill information includes the skills that the simulation object has, the skills required for the work role, and the skills that the simulation object needs but does not have. The specific knowledge and abilities required to perform specific work responsibilities are different, including both hard skills such as programming languages, the use of data analysis tools, and financial knowledge, as well as soft skills such as the ability to work and communicate effectively with others, problem-solving skills, and the ability to adapt to changes.

Step 102 is about selecting a suitable virtual robot based on the characteristics of the selected work role and adding specific skill packages to it to ensure that the model is competent for the work responsibilities of the role. Based on the work responsibilities and skill requirements of the role, selecting the type of virtual robot that can handle the relevant tasks. For example, if the role involves a lot of data analysis and prediction, you may need to select a model with advanced data analysis and machine learning capabilities as a functional model. For another example, if the role involves content creation, etc., you may need a more intelligent text generation model as a functional model. When the role involves communicating with others, chatbots, sentiment analysis engines, etc. can be selected as functional models. Virtual robots can be customized and optimized according to the needs of specific work roles to improve efficiency, reduce errors, support decision-making, and provide users with a better service experience. With the continuous development of artificial intelligence technology, more virtual robots specifically for specific work roles may appear in the future to meet the increasingly complex and diverse workplace needs. In addition, it is necessary to establish an evaluation of virtual robots, including: evaluating the historical performance of the model on similar tasks, such as accuracy, efficiency and stability.

In some embodiments, in the preset database, virtual robots divided by work roles are pre-stored, and the role information of the virtual robots, including age, gender, and education, can be customized and marked with skill tags corresponding to the functional model. In actual applications, the basic skills required to complete work responsibilities are determined in advance, and virtual robots with corresponding skill tags are searched in the database based on the basic skills, so that enterprises or individuals can quickly find the most suitable virtual robots for specific tasks, reducing the time and cost of manual screening, while improving work efficiency. In the database, each virtual robot has its preset role information (such as age, gender, and education), which may be used for artificial intelligence applications in certain specific scenarios, such as role-playing when simulating user interactions. Each model is also given skill tags, which reflect the functions that the model can perform or the areas in which it is particularly good. When a work needs to be completed, the database is queried for virtual robots with corresponding skill tags based on the required skills. Database queries may be based on keyword searches, or more complex algorithms may be used to match the most appropriate model, such as similarity scores.

For example, finding a data analyst work role that needs to perform data cleaning, data exploration analysis, and data visualization.

Defining skills: data cleaning, statistical analysis, data visualization.

Database query: searching for virtual robots with the skill labels of “data cleaning”, “statistical analysis”, and “data visualization”in the preset database.

Selecting model: assuming that the database returns three virtual robots A, B, and C, among which model B has the highest skill match.

Applying model: deploying model B to perform the work responsibilities of a data analyst.

For example, when adding skill software packages to virtual robots, steps specifically include: clarifying what specific tasks the virtual robot needs to perform and the skills required to complete these tasks. For example, if the virtual robot is a model for data processing, it may require skills such as data cleaning, data conversion, statistical analysis, and machine learning algorithms. According to the skill requirements, selecting appropriate software packages or libraries. For example, for data processing tasks, the following packages may be required: Pandas, NumPy, Scikit-learn and Matplotlib (or Seaborn). Pandas is configured for data cleaning and conversion. NumPy is configured for numerical calculations. Scikit-learn is configured for machine learning algorithms. Matplotlib (or Seaborn) is configured for data visualization. After that, installing the required software packages in the environment where the virtual robot runs through the package manager. At the same time, importing the relevant software packages into the code of the virtual robot, encapsulating the code for executing specific skills into functions or methods, and then the virtual robot can call these functions to complete the task, so as to better call them when performing the task.

When choosing a skill software package, we should pay attention to selecting specific skills based on role information and work responsibilities, such as data analysis, programming, document processing, etc., and determine which skills are core and which are secondary to optimize resource allocation. In addition, we should choose a skill software package that is compatible with the technology stack of the virtual robot, and ensure that the skill software package can fully cover the required skills.

Step 103 involves identifying target work projects that can be replaced by virtual robots in the selected work responsibilities, parsing the execution process of these items, determining the software permissions required by the virtual robot, and building the initial logic chain of project execution. Among them, the screening criteria for work projects are highly repeatable, clear rules, and standardized workflows. For example, regular tasks such as daily data aggregation and weekly report generation or tasks with fixed cycles. In addition, in practical applications, the complexity of the project should also be considered to ensure that the existing capabilities of the virtual robot are sufficient to handle it. Overly complex projects may require more advanced virtual robots or more customized development.

Breaking down the work projects into a series of executable steps, such as data collection, data processing, decision making, and result output. Determining the software and tools used in each step, such as database query, specific office software, data processing scripts, etc. This part of the content can be summarized by the virtual robot and confirmed by the simulation object. If necessary, a flowchart or workflow diagram can be created to clearly show every link of the project from start to finish. After that, according to the workflow, determining which software or system resources the virtual robot needs to access to ensure that the virtual robot can perform the required operations, such as reading files, performing database queries, sending emails, etc. In step 103, it is only necessary to confirm the required permissions. When the virtual robot actually starts to execute the work project, the permissions are granted to ensure data security. Regarding the granting of permissions, the principle of least privilege must be followed.

In some embodiments, the initial logic chain includes: the source of input data, data processing and analysis, decision-making logic, output result processing, and exception handling mechanism. Regarding the design of the initial logic chain, based on the analysis of the workflow, the logic chain for the virtual robot to perform tasks is designed. That is, a series of instructions executed in a specific order. For steps that need to respond differently according to conditions, conditional branch logic is designed, such as “if data X exceeds threshold Y, then executing step Z”. At the same time, an exception handling mechanism is constructed so that the virtual robot can pause, record errors, or try alternative solutions when encountering problems. The test of the initial logic chain should not only test each independent step to ensure that the virtual robot can execute correctly, but also test the entire logic chain to ensure that all steps are executed coherently without conflicts or omissions. At the same time, the execution efficiency of the virtual robot should be analyzed and the logic chain should be optimized, such as reducing unnecessary steps and improving algorithm performance.

The following are virtual robots, skill requirements, software involved, and work projects that can be replaced for common work roles as follows.

1. Data analyst

Virtual robot: automatic feature selection, anomaly detection, predictive modeling.

Skills: statistics, data visualization, machine learning algorithms.

Software: Python (Pandas, scikit-learn), R, Tableau, Power BI.

Work projects that can be replaced: data cleaning, basic data exploratory analysis, pattern recognition.

2. Customer service representative

Virtual robot: chatbot, speech recognition, sentiment analysis.

Skills: customer service, communication, problem solving.

Software: Dialogflow, IBM Watson, Zendesk.

Work projects that can be replaced: FAQ, preliminary complaint handling, simple inquiries.

3. Financial accounting

Virtual robot: financial forecasting, automated auditing, compliance checks.

Skills: accounting principles, tax knowledge, financial analysis.

Software: SAP, Oracle, QuickBooks.

Work projects that can be replaced: account classification, invoice processing, general report generation.

4. Physician assistant

Virtual robot: medical image analysis, disease diagnosis assistance, patient medical record.

Skills: medical knowledge, patient care, health education.

Software: DeepMind Health, IBM Watson for Oncology.

Work projects that can be replaced: basic image reading, symptom analysis, electronic medical record organization.

5. Software developer

Virtual robot: automatic code generation, error detection, code optimization suggestions.

Skills: programming language, software architecture, testing.

Software: GitHub Copilot, JetBrains Kite.

Work projects that can be replaced: code snippet generation, basic bug fixes, simple function implementation.

6. Human Resources Specialist

Virtual robot: resume screening, candidate evaluation, employee satisfaction prediction.

Skills: recruitment strategy, interview skills, employee relations.

Software: ZapRecruit, Mya Systems.

Work projects that can be replaced: preliminary resume screening, scheduling interviews, sending standardized emails.

7. Content creator

Virtual robot: article writing, video editing, image generation.

Skills: creative writing, media production, SEO.

Software: Grammarly, Adobe Creative Suite, Midjourney AI.

Work projects that can be replaced: news release writing, basic graphic design, video clip editing.

8. Educators

Virtual robots: student performance prediction, personalized learning recommendations.

Skills: teaching methods, course design, student assessment.

Software: Knewton, Edmentum.

Work projects that can be replaced: student progress tracking, basic feedback generation, course content recommendation.

9. Logistics and supply chain managers

Virtual robots: inventory optimization, demand forecasting, transportation route planning.

Skills: supply chain management, logistics planning, data analysis.

Software: Blue Yonder, SAP Ariba.

Work projects that can be replaced: inventory level monitoring, transportation scheduling, supplier evaluation.

10. Marketing experts

Virtual robots: customer segmentation, advertising optimization, market trend prediction.

Skills: market analysis, digital marketing, brand management.

Software: Google Analytics, HubSpot, Salesforce Pardot.

Work projects that can be replaced: market research, customer behavior analysis, advertising effect monitoring.

Step 104 mainly involves collecting and understanding the work habits of the simulation objects by analyzing their behaviors when performing work projects. The virtual robot records the operation data of the simulation objects on the terminal (such as a computer, workstation) in the background, which may include keyboard input, mouse clicks, application usage frequency, operation time, etc. From the large amount of terminal data collected, filtering out the data directly related to the selected work project. This may involve identifying specific steps in the files, applications or workflows related to the project. Performing in-depth analysis of the filtered project data to identify the common operation patterns, preferences and habits of the simulation objects. For example, they may tend to use specific shortcut keys, perform tasks in a specific order, or perform certain operations at specific times.

In some embodiments, the process of obtaining project data includes: real-time monitoring of the terminal operation of the simulation object when executing a target work project to obtain terminal data, and the terminal operation includes keyboard input, mouse movement, click, program interaction of a window to manage the virtual robot; collecting a timestamp, sequence and frequency of each terminal operation to form a corresponding operation log, and incorporating the operation log into the terminal data; filtering out data directly related to the selected work project from the terminal data, and eliminating irrelevant data through identification methods including keyword search, application identifier identification or specific operation mode identification to obtain the project data.

Among them, the virtual robot will monitor the operation of the simulation object on the terminal in real time when the simulation object executes the work project, including but not limited to keyboard input, mouse movement, click, opened or closed windows, used applications and functions, etc. Keyboard input: record every character typed, including shortcut key combinations. Mouse movement: track the movement trajectory of the mouse pointer. Click event: capture clicks and double clicks of the left mouse button, right mouse button, and scroll wheel. Window management: track the opening, closing, maximization, minimization and switching of windows. Application interaction: record the startup, closing, menu selection and function call of the application. The timestamps, sequence and frequency of these operations are collected to form a detailed operation log. The timestamp is used to capture the exact time when the operation occurs. The sequence indicates the order of operations; and the frequency indicates the number of times the same operation is repeated. These information are integrated into a detailed operation log and becomes part of the terminal data. Data directly related to the selected work project is filtered out from the large amount of terminal data collected. It involves using keyword searches, application identifiers or specific operation modes to identify activities closely related to the project. Keyword search: searching for keywords or phrases related to the work project, such as project names, specific file paths or commands. Application identifier identification: using the unique identifier of the application (such as process ID, software name) to identify which operations are related to the current work project. Specific operation mode identification: analyzing the operation sequence and identify the operation mode or process closely related to the work project, such as opening a specific folder, executing a series of commands, or adjusting the window layout. Eliminating operation data that is not related to the work project to reduce the complexity of analysis and improve efficiency.

In some embodiments, the process of obtaining the habit data includes: using a pre-trained habit analysis model to analyze project data, clustering similar operations, and combining a preset long short-term memory network to analyze related operations in the time dimension, to obtain the habit pattern of the simulation object when executing the work project, the habit pattern includes the time point of switching software, the target order of processing data, tool options, interface layout and shortcut key usage; based on the habit pattern, analyzing the most common operation sequence of the simulation object when executing the work project, the operation sequence includes the normal working sequence of the simulation object when executing the work project, and the decision-making mode and corresponding working sequence when facing anomalies; summarizing the habit pattern and operation sequence, and encoding the habit pattern and the operation sequence into a format that can be parsed by the virtual robot to obtain habit data.

When data analysis is performed, data mining and machine learning techniques is used to identify the habit patterns of the simulation object when executing the project. For example, analyzing at what time they tend to start a specific software, or the specific order when processing data. At the same time, learning the preferences of the simulation object when processing work projects, such as specific tool options, interface layout or shortcut key usage. Clustering analysis is used to classify similar operations together and identify the recurring behavior patterns of the simulation object when executing work projects. For example, if the simulation object always opens a browser and logs in to a specific website before starting each project, this sequence of actions will be clustered together as a habit pattern. Long short-term memory network (LSTM) is a special type of recurrent neural network that is good at processing time series data and can remember long-term dependencies. When analyzing project data, LSTM is used to understand the time sequence of the simulation object when performing operations and identify time-related habit patterns. For example, LSTM can help identify the simulation object's habit of opening the email client at a specific time every day, or performing data backup at a fixed time every week.

Habit patterns include: the time to turn on or off software, such as opening the mailbox every morning and closing all work-related software before leaving work; the target order of processing data, such as importing data first, then cleaning, analyzing, and finally generating reports; tool options and interface layout, such as the tool configuration and work interface layout preferred by the simulation object; and shortcut key usage. When identifying behavioral habits, identifying the most common operation sequence of the simulation object when performing work projects helps the virtual robot learn the natural working order and abnormal working order of the workflow. Analyzing the decision-making mode of the simulation object when facing choices, such as how to deal with data anomalies. On the basis of obtaining habit patterns, further analyzing the most common operation sequence of the simulation object when performing work projects. This includes not only normal operation processes, but also decision-making patterns and coping strategies when encountering abnormal situations. For example, if an error is found when importing data, the simulation object may have a fixed set of processing processes, such as checking the data source, modifying the format, and trying to import again. Summarizing all the analyzed habit patterns and operation sequences to form a comprehensive view, which will serve as the basis for virtual robot learning and imitation.

Finally, the collected habit data is converted into a structured form for the virtual robot to understand and apply. This may include encoding habit data into a format that the model can parse, such as a decision tree, rule set, or input to a neural network. The analyzed habit data is fed back to the virtual robot to optimize its execution logic chain to make it closer to the actual operating habits of the simulation object. In addition, the virtual robot is designed to be able to learn continuously and continuously improve its understanding of the simulation object's habits over time.

In some embodiments, the virtual robot is given the permission to start background screen recording when the software is running, obtaining the terminal data by recording a screen of the simulation object when executing the work project at the terminal within a target period; analyzing the terminal data frame by frame, and comparing whether there is a distinction between two adjacent frame images; marking frame images with distinctions as change frames, and searching for change areas in all change frames; based on running logic of the software, analyzing an operation behavior of the simulation object and interface changes corresponding to the operation behavior from the change area, and obtaining project data of the target time period after confirmation by the simulation object; and summarizing project data of each period, analyzing basis data of the simulation object performing the operation behavior according to the running logic of the software and the interface changes corresponding to the operation behavior, and obtaining habit data of the simulation object by combining the basis data and the corresponding operation behavior.

The virtual robot needs to request the permission of background screen recording from the operating system or application, which usually involves access to a specific application programming interface (API). To configure the screen recording function in the virtual robot, the recording parameters, such as recording frequency, recording area, storage location, etc., need to be set in advance. At the same time, in order to ensure that the use of screen recording permissions complies with data protection and privacy regulations, Starting screen recording within the preset target period to ensure that the time period when the simulation object executes the work project is covered. Storing the screen recording data in a safe location for subsequent analysis for later analysis. Converting the screen recording file into an analyzable format, using video editing software to capture the execution of the work project, and removing irrelevant clips. Preliminarily watching the screen recording and manually marking key events and operations, such as start and end time, software used, and operation sequence. Reading the screen recording file and analyzing the image data frame by frame, which involves computer vision technology. Using computer vision and machine learning tools to automatically analyze the screen recording data to identify mouse tracks, keyboard heat maps, interface interactions, etc. For example, you can use OpenCV for image processing, or use deep learning models to identify operations on the screen. Comparing two adjacent frames of images to identify the areas that have changed in the image, specifically through pixel difference algorithms. Locating the image areas that have changed in the changed frames, which are often related to the operation of the simulation object. Based on the running logic of the software and the changes in interface elements, inferring the operation behavior of the simulation object, such as clicking buttons, entering text, etc. Using analysis tools to find out the common operation modes, preferences, specific steps in the workflow, and behavioral habits at decision points of the simulation object. These changes may require confirmation or verification of the simulation object to ensure that the analyzed operation behavior is correct. Summarizing the operation behavior and interface changes, and analyzing the basis for the simulation object to make operations, such as the events responded to and the triggered operation conditions. Through statistical and machine learning methods, the habit patterns of the simulation object are identified, such as common operation sequences, preference settings, decision-making tendencies, etc. Integrating the basis data and operation behaviors into the habit data of the simulation object requires building a data model or database to store and manage this information. Marking frames with distinctions as change frames helps to focus on analyzing the operation moments of the simulation object. Based on computer vision and behavioral analysis, through screen recording and detailed data analysis, the virtual robot can more accurately capture the subtle habits of the simulation object when performing work projects, so that it can be closer to human behavior when imitating, and improve the usability and acceptance of the automation system.

The terminal data collected in step 104 covers a variety of behavioral traces of the simulation object when executing the work project. The comprehensive collection of these data helps the virtual robot to more accurately analyze and understand the habits of the simulation object. In some embodiments, the terminal data includes: the timestamp triggered by the terminal input device and the instructions sent, the log file of the software, the editing of the file and its timestamp, and the access record of the website. The logging function of the operating system or a third-party log collection tool can be used to automatically record the above-mentioned types of activities. Special desktop monitoring software can also be used to comprehensively track and record all activities of the simulation object on the terminal. Recording the timestamp of each keyboard stroke and mouse action, including keystrokes, scrolling, clicking, etc., and the corresponding action instructions. These data can reveal the operation rhythm, preferences and efficiency of the simulation object. Collecting the log files generated when the software is running. These files record the running status, error messages, function calls, etc. of the software, which helps to understand the specific operations and problems in the use of the software. Recording the timestamps of operations such as creation, editing, and saving of files, as well as the specific changes made. This is very important for understanding the workflow and decision-making process, especially when the work involves document or code editing. Collecting website access records, including access time, browsed pages, dwell time, etc. This can be helpful in analyzing the online behavior of the simulation object, especially for work roles that require web research or documentation.

Step 105 is about integrating the habit data collected and analyzed previously into the execution logic of the virtual robot so that the virtual robot can imitate the habits of the simulation object to execute the work project. In step 104, the habit data of the simulation object when executing the work project has been collected and analyzed, including the operation sequence, preference settings, decision-making mode, etc. In this step, it is necessary to convert these habit data into a logic chain that the virtual robot can understand and execute. Specifically, it includes: mapping habits to logic chains, and constructing a decision tree or state machine. Mapping habits to logic chains means converting the habitual behavior of the simulation object into the logical instructions of the virtual robot. For example, if the simulation object always executes a certain function immediately after opening a certain software, then in the logic chain of the virtual robot, these two steps should be closely connected. Constructing a decision tree or state machine means constructing a decision tree or state machine based on the habit data, which will guide the virtual robot to make the same or similar decisions as the simulation object when encountering similar situations. Listing all permissions required by the simulation object when executing the work project, including but not limited to file access, network connection, application control, etc. In the operating environment of the virtual robot, assigning the same permissions to the virtual robot as the simulation object to ensure that it can access all necessary resources. In addition, it is also necessary to ensure that the execution environment of the virtual robot is consistent with the working environment of the simulation object, including software version, data source, workspace configuration, etc. Starting the virtual robot and let it start executing the work project according to the habitual logic chain. The virtual robot should be able to independently handle the work project, including data collection, processing, decision-making and result output.

When the virtual robot executes the work project, there will be three main situations: when encountering a completely matched demand, when encountering a similar but not completely the same demand, and when encountering a demand that is neither the same nor similar. As shown in FIG. 3, the virtual robot includes the following steps in the process of executing a work project:

Step 301, obtaining the requirements of the current work project.

Step 302, determining whether there are requirements in the project data that are the same as the requirements of the current work project. If it is determined that the execution result of step 302 is “yes”, then executing step 303 to obtain the processing method. If it is determined that the execution result of step 302 is “no”, then executing step 304 to determine whether there are requirements similar to the current work project in the project data.

If it is determined that the execution result of step 304 is “yes”, then executing step 305 to adjust the habitual logic chain. If it is determined that the execution result of step 304 is “no”, then executing step 306 to reconstruct the habitual logic chain.

After step 303, it also includes step 307, repeated execution.

After step 305, it also includes step 308, intelligent execution.

After step 306, it also includes step 309, intelligent execution.

Among them, the specific meanings of repeated execution and intelligent execution have been explained in the relevant parts and will not be repeated here.

In some embodiments, in a process of the virtual robot executing the work project, the specific steps are as follows: in response to that requirements of the work project are the same as one or more requirements recorded in the project data, enabling the virtual robot to directly repeat the execution according to a processing method recorded in the project data; and in response to that the requirements of the work project are different from all the requirements recorded in the project data, but similar to one or more requirements, enabling the virtual robot to compare characteristics of requirements of a current work project and characteristics of similar requirements in the project data to identify differences, and intelligently adjusting corresponding links in the habitual logic chain based on the differences to achieve intelligent execution. For example, establishing a memory library or knowledge map to record various demands and solutions that have been processed in the past. When encountering the same requirements, the virtual robot can directly refer to the processing methods in this knowledge base without recalculation or analysis.

When the work project requirements faced by the virtual robot are exactly the same as one or more requirements recorded in the project data it stores, the virtual robot will take the most direct action path-that is, repeating the processing methods already in the project data. In this case, the virtual robot does not need additional calculations or decisions, because it has mastered the correct process of how to handle such requirements in past learning or programming. For example, if the project data records the complete process of processing invoices, including receiving, verifying, entering the system, paying and archiving, then when a new invoice processing request arrives and its requirements are completely consistent with the records, the virtual robot will automatically follow this process without human intervention.

When the work project requirements encountered by the virtual robot are not exactly the same as all the requirements recorded in the project data, but are similar to some of them, it will not simply refuse to execute or blindly apply the old processing methods, but will enter a more complex intelligent decision-making process. First, the virtual robot will compare the characteristics of the requirements of the current work project with the characteristics of similar requirements in the project data and identify the differences between the two. For example, if the previous invoice processing cases were all for domestic suppliers, and the current requirement is to process an invoice for an international supplier, then the attribute of “international” is the difference. Next, based on the identified differences, the virtual robot will intelligently adjust the corresponding links in its habitual logic chain to more appropriately execute the current work project. The habitual logic chain is a series of organized steps followed by the virtual robot when performing tasks, which can change dynamically according to specific circumstances.

For example, an advanced similarity evaluation algorithm (such as a natural language processing model based on deep learning) is used to identify and compare the similarity between current requirements and historical requirements. Extracting key features from the requirements, such as keywords, process steps, target results, etc., and then comparing them with the characteristics of the requirements stored in the knowledge base to identify similarities. Designing a special intelligent adjustment module that can automatically adjust the existing logic chain according to the identified differences, including parameter fine-tuning, process modification, or introduction of new decision nodes.

In the above example, the virtual robot may intelligently adjust its processing process, such as adding currency conversion, considering international tax regulations, using different payment methods, etc., to ensure that the task can be completed accurately even when processing international supplier invoices.

In some embodiments, in response to that the requirements of the work project are neither the same nor similar to all the requirements recorded in the project data, enabling the virtual robot to analyze requirements of the current work project, construct a new initial logic chain, merge the habit data into the new initial logic chain to obtain a new habitual logic chain, and execute the work project in a manner that imitates the simulation object in the face of new requirements according to the new habitual logic chain. For example, an expert system is integrated into the virtual robot, which contains the knowledge and experience of experts in a specific field and is used to guide the virtual robot's decision-making process when facing unknown requirements. By using machine learning and reinforcement learning techniques, the virtual robot can learn the best solution to new requirements through trial and error. The model is trained using a large amount of historical data to enable it to recognize patterns and rules, so as to better respond to new requirements.

When the requirements of the work project encountered by the virtual robot are neither the same nor similar to all the requirements recorded in the project data, it means that the robot is facing an unprecedented challenge and needs to show a high degree of autonomy and innovation to respond to new situations. The virtual robot will first deeply analyze the requirements of the current work project and understand the core elements and goals of the task. The analysis of requirements includes: requirement interpretation, environmental perception, and feasibility assessment. Requirements interpretation means parsing the requirement document of the work project and extracting key information, such as task objectives, data types involved, and expected output formats. Environmental perception means identifying the applications, tools, and data sources required to execute the work project. Feasibility assessment means judging whether the work project can be completed with existing skills and resources, or whether additional skill packages or data support are needed.

After understanding the requirements of the work project, the virtual robot will begin to build a new initial logic chain, which is the basic framework for executing the new task. This process may include: task decomposition, process design and decision making. Task decomposition is to decompose the work project into a series of smaller and manageable subtasks. Process design is to design the order and method of completing these subtasks to form a preliminary execution process. Decision making is to determine the decision points that may be encountered during the execution process and the corresponding processing strategies.

Subsequently, the virtual robot will integrate the previously acquired data related to the habits of the simulation object into the new initial logic chain in order to imitate the possible behavior of the simulation object when facing new requirements. First, embedding the habit pattern into the key nodes of the logic chain, such as specific tool options, interface layout, and shortcut key usage. Second, integrating the decision-making pattern of the simulation object when facing choices into the logic chain to guide the robot to make decisions under uncertainty. Through the above steps, the virtual robot builds a new habitual logic chain, which is an execution plan that combines the new task requirements and the habits of the simulation object. This logic chain not only includes the steps to complete the task, but also incorporates the habits and preferences of the simulation object when dealing with similar or different situations. Finally, the virtual robot executes the work project according to the new habitual logic chain, imitating the execution method that the simulation object may take when facing new requirements.

After the virtual robot starts to execute the work project, its execution needs to be monitored to ensure that it can accurately imitate the habits of the simulation object and optimize it according to the actual situation. The data of the virtual robot is collected during the execution process, including execution time, error rate, resource consumption, etc. According to the monitoring data, we can analyze the execution efficiency and accuracy of the virtual robot, identify any deviations or deficiencies, and make necessary adjustments and optimizations to the habitual logic chain. In some embodiments, it also includes: collecting feedback from actual users or stakeholders to understand whether the performance of the virtual robot meets expectations and whether there is room for improvement. Then, based on the feedback, we can iteratively improve the virtual robot and continuously optimize the habitual logic chain to make it more in line with the habits and workflow of the simulation object.

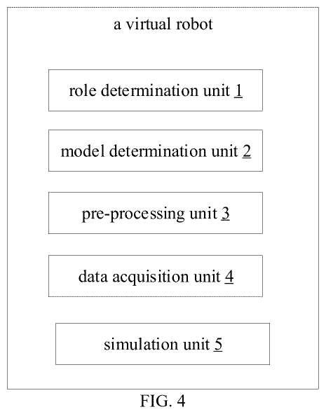

The present application provides a virtual robot, which systematizes the above-mentioned method for simulating work roles based on a virtual robot to make it more practical. A schematic structural view of a virtual robot is shown in FIG. 4, and the specific scheme is as follows:

A virtual robot, including:
role determination unit 1 is configured to select a simulation object corresponding to a target work role, and parse role information, work responsibilities and skill information of the simulation object;
model determination unit 2 is configured to select a virtual robot based on the role information and the work responsibilities, and add a skill software package corresponding to the skill information to the virtual robot to enable the virtual robot to call the skill software package to perform tasks;
pre-processing unit 3 is configured to select a work project executed by the simulation object at a terminal and capable of being replaced in the work responsibilities, parse an execution process and a software involved in the work project, determine authority required for the virtual robot to execute the work project, and construct an initial logic chain of the work project based on the execution process;
data acquisition unit 4 is configured to obtain terminal data of the simulation object when the simulation object executing the work project at the terminal through the virtual robot, filter out project data related to the work project from the terminal data, and obtain habit data of the simulation object by analyzing the project data in a process of the simulation object executing the work project; and
simulation unit 5 is configured to couple the habit data to the initial logic chain to obtain a habitual logic chain, and give the virtual robot a same authority as the simulation object to enable the virtual robot to imitate a habit of the simulation object according to the habitual logic chain to execute the work project.

The present application provides a electronic device, including: a processor and a memory for storing a computer program run on the processor. The processor, when running the computer program, executes the method for simulating work roles based on the virtual robot. The electronic device can be any mobile phone, server or other terminal, as long as it can be equipped with the method of running the present application.

The present application provides a computer program product, which includes computer instructions, which are stored in a computer-readable storage medium. The processor of a computer device reads the computer instructions from the computer-readable storage medium, and the processor executes the computer instructions, so that the computer device executes a method for simulating work roles based on a virtual robot. A method for simulating work roles based on a virtual robot is applied to a computer program product for easy execution.

The present application also provides a computer-readable storage medium, on which a computer program is stored, and when the program is executed by the processor, the steps of a method for simulating work roles based on a virtual robot as described above are implemented.

The computer storage medium of the present application may adopt any combination of one or more computer-readable media. The computer-readable medium may be a computer-readable signal medium or a computer-readable storage medium. The computer-readable storage medium may be, for example, but not limited to: an electrical, magnetic, optical, electromagnetic, infrared, or semiconductor system, device or device, or any combination of the above. More specific examples of computer-readable storage media (a non-exhaustive list) include: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present application, a computer-readable storage medium can be any tangible medium containing or storing a program that can be used by or in combination with an instruction execution system, an apparatus or a device. The present application applies a method for simulating work roles based on a virtual robot to a computer-readable storage medium, on which a computer program is stored, and when the program is executed by a processor, the steps of the method for simulating work roles based on a virtual robot provided by the present application are implemented, which is simple, fast, easy to store, and not easy to lose.

The present application provides a method for simulating work roles based on a virtual robot, a virtual robot and an electronic device, which simulates the habits and workflow of a simulation object corresponding to a target work role through a virtual robot, imitates the decision-making mode, operation habits and preference settings of the simulation object, and provides highly personalized and customized services, thereby providing services that are more in line with personal style and improving user experience and satisfaction. When simulating the execution of repetitive and rule-defined tasks, virtual robots can accurately follow the customary logic chain and complete tasks quickly and accurately, which can greatly improve efficiency and reduce errors caused by human negligence or fatigue.

It should be understood by those skilled in the art that the modules of the present application described above can be implemented by a general computing system. They can be concentrated on a single computing system, or distributed on a network composed of multiple computing systems; optionally, they can be implemented by executable program codes of a computer system, so that they can be stored in a storage system and executed by the computing system, or they can be made into individual integrated circuit modules, or multiple modules or steps therein can be made into a single integrated circuit module for implementation. In this way, the present application is not limited to any specific combination of hardware and software.

It is noted that the above are only preferred embodiments of the present application and the technical principles used. Those skilled in the art will understand that the present application is not limited to the specific embodiments here, and that various obvious changes, readjustments and substitutions can be made for those skilled in the art without departing from the scope of protection of the present application. Therefore, although the present application is described in more detail through the above embodiments, the present application is not limited to the above embodiments, and may include more other equivalent embodiments without departing from the concept of the present application, and the scope of the present application is determined by the scope of the attached claims.

The above disclosure is only a few specific implementation scenarios of the present application, but the present application is not limited thereto, and any changes that can be thought of by those skilled in the art should fall within the scope of protection of the present application.

What is claimed is:

1. A method for simulating work roles based on a virtual robot, comprising:
selecting a simulation object corresponding to a target work role, and parsing role information, work responsibilities and skill information of the simulation object;
selecting the virtual robot based on the role information and the work responsibilities, and adding a skill software package corresponding to the skill information to the virtual robot to enable the virtual robot to call the skill software package to perform tasks;
selecting a work project executed by the simulation object at a terminal and capable of being replaced in the work responsibilities; parsing an execution process and a software involved in the work project; determining authority required for the virtual robot to execute the work project, and constructing an initial logic chain of the work project based on the execution process;
in a process of the simulation object executing the work project, obtaining terminal data of the simulation object when executing the work project at the terminal through the virtual robot, filtering out a project data related to the work project from the terminal data, and obtaining habit data of the simulation object by analyzing the project data; and
coupling the habit data to the initial logic chain to obtain a habitual logic chain, and giving the virtual robot a same authority as the simulation object to enable the virtual robot to imitate a habit of the simulation object according to the habitual logic chain to execute the work project.

2. The method of claim 1, wherein the virtual robot executing the work project comprises:
in response to that requirements of the work project are the same as one or more requirements recorded in the project data, enabling the virtual robot to directly repeat the execution according to a processing method recorded in the project data; and
in response to that the requirements of the work project are different from all the requirements recorded in the project data, but similar to one or more requirements, enabling the virtual robot to compare characteristics of requirements of a current work project and characteristics of similar requirements in the project data to identify differences, and intelligently adjusting corresponding links in the habitual logic chain based on the differences to achieve intelligent execution.

3. The method of claim 2, further comprising:
in response to that the requirements of the work project are neither the same nor similar to all the requirements recorded in the project data, enabling the virtual robot to analyze requirements of the current work project, construct a new initial logic chain, merge the habit data into the new initial logic chain to obtain a new habitual logic chain, and execute the work project in a manner that imitates the simulation object in the face of new requirements according to the new habitual logic chain.

4. The method of claim 1, wherein the virtual robot is given a permission to start background screen recording in response to that the software is running, obtaining the terminal data by recording a screen of the simulation object when executing the work project at the terminal within a target period;
analyzing the terminal data frame by frame, and comparing whether there is a distinction between two adjacent frame images;
marking frame images with distinctions as change frames, and searching for change areas in all change frames;
based on running logic of the software, analyzing an operation behavior of the simulation object and interface changes corresponding to the operation behavior from the change area, and obtaining project data of the target time period after confirmation by the simulation object; and
summarizing project data of each period, analyzing basis data of the simulation object performing the operation behavior according to the running logic of the software and the interface changes corresponding to the operation behavior, and obtaining habit data of the simulation object by combining the basis data and the corresponding operation behavior.

5. The method of claim 1, wherein the virtual robot comprises an artificial virtual robot and one or more functional models, and the artificial virtual robot is able to call each functional model and select the functional model based on the skill information; and
in a preset database, virtual robots divided by work roles are pre-stored, and role information of the virtual robot comprising age, gender, and education level is capable of being customized and marked with skill labels of corresponding functional models; determining basic skills required to complete the work responsibilities, and searching for virtual robots with corresponding skill labels in the preset database based on the basic skills.

6. The method of claim 1, wherein a process of obtaining the project data comprises:
monitoring a terminal operation of the simulation object in real time when the simulation object executing a target work project to obtain the terminal data, wherein the terminal operation comprises keyboard input, mouse movement, click, program interaction of a window to manage the virtual robot;
collecting a timestamp, a sequence and a frequency of each terminal operation to form a corresponding operation log, and incorporating the operation log into the terminal data; and
filtering out data directly related to a selected work project from the terminal data, and eliminating irrelevant data through identification methods comprising keyword search, application identifier identification or specific operation mode identification to obtain the project data.

7. The method of claim 1, wherein a process of obtaining the habit data comprises:
using a pre-trained habit analysis model to analyze the project data, obtaining a habit pattern of the simulation object when the simulation object executing the work project through clustering similar operations, in combination with a preset long short-term memory network to analyze related operations in a time dimension, wherein the habit pattern comprises a time point of switching software, a target order of processing data, tool options, interface layout and shortcut key usage;
based on the habit pattern, analyzing a most common operation sequence of the simulation object when the simulation object executing the work project, wherein the operation sequence comprises a normal working sequence of the simulation object when the simulation object executing the work project, and a decision-making mode and corresponding working sequence when the simulation object facing anomalies; and
summarizing the habit pattern and the operation sequence, and encoding the habit pattern and the operation sequence into a format capable of being parsed by the virtual robot to obtain the habit data.

8. The method of claim 1, wherein the role information comprises a position, an age, a gender, and an education of the simulation object;
the work responsibilities comprise daily tasks and responsibilities of the simulation object;
the skill information comprises skills possessed by the simulation object, skills required for the work role, and skills needed by the simulation object but not having; and
the initial logic chain comprises source of input data, data processing and analysis, decision-making logic, output result processing, and exception handling mechanism.

9. A virtual robot, comprising:
a role determination unit, configured to select a simulation object corresponding to a target work role, and parse role information, work responsibilities and skill information of the simulation object;
a model determination unit, configured to select a virtual robot based on the role information and the work responsibilities, and add a skill software package corresponding to the skill information to the virtual robot to enable the virtual robot to call the skill software package to perform tasks;
a pre-processing unit, configured to select a work project executed by the simulation object at a terminal and capable of being replaced in the work responsibilities, parse an execution process and a software involved in the work project, determine authority required for the virtual robot to execute the work project, and construct an initial logic chain of the work project based on the execution process;
data acquisition unit, configured to obtain terminal data of the simulation object when the simulation object executing the work project at the terminal through the virtual robot, filter out project data related to the work project from the terminal data, and obtain habit data of the simulation object by analyzing the project data in a process of the simulation object executing the work project; and
simulation unit, configured to couple the habit data to the initial logic chain to obtain a habitual logic chain, and give the virtual robot a same authority as the simulation object to enable the virtual robot to imitate a habit of the simulation object according to the habitual logic chain to execute the work project.

10. An electronic device, comprising:
a processor; and
a memory for storing a computer program run on the processor;
wherein the processor, when running the computer program, executes the method for simulating work roles based on the virtual robot of claim 1.
